(19) United States
(12) Patent Application Publication
(10) Pub. No.: US 2011/0148874 A1
(43) Pub. Date: Jun. 23, 2011

(54) SYSTEM AND METHOD FOR TRANSFORMING MUSCLES OF CHARACTER MODEL

(75) Inventors: Young Mi CHA, Busan (KR); II Kyu Park, Daejeon (KR); Jeung Chul Park, Jeonju (KR); Ji Hyung Lee, Daejeon (KR); Bon Ki Koo, Daejeon (KR)

(73) Assignee: Electronics and Telecommunications Research Institute, Daejeon (KR)

(21) Appl. No.: 12/783,239

(22) Filed: May 19, 2010

(30) Foreign Application Priority Data
Dec. 18, 2009 (KR) 10-2009-0127344

(51) Int. Cl. G06T 17/00

(52) U.S. Cl. 345/420

(57) ABSTRACT

Disclosed herein is a method and system for transforming the muscles of a character model. The muscles of a target model are created using the muscle information of a reference model. The system includes a reference model processor and a target model processor. The reference model processor creates a reference feature volume, that is, a 3D geometric shape, based on the skeleton and appearance information of the reference model, and subordinates the muscle information of the reference model to the feature volume. The target model processor deforms the reference feature volume to be suitable for the target model, and applies the muscle information of the reference model to the target model, thereby creating muscles for the target model based on the extent of the deformation of the reference feature volume.

### CROSS-REFERENCE TO RELATED APPLICATIONS

This application claims priority under 35 U.S.C. §119 to Korean Patent Application No. 10-2009-127344, filed on Dec. 18, 2009, in the Korean Intellectual Property Office, the disclosure of which is incorporated herein by reference in its entirety.

### TECHNICAL FIELD

The following disclosure relates to a system and method for transforming the muscles of a character model, and, more particularly, to a system and method for creating the muscles of a new character using the muscle information of an existing character when the muscles of the character model are set.

### BACKGROUND

In skeleton-based animation work, in order to create an animated character such as a person or an animal, a rigging/skinning process of modeling the surface of a character, constructing a skeleton structure suitable for the animation of the character and connecting the surface to the skeleton is performed. In this case, in order to represent a character realistically, a muscle simulation technique is additionally used. In order to use a muscle simulation technique, the work of additionally determining the shapes and locations of muscles and making the muscles work in conjunction with bones to implement the realistic motions of the muscles based on the motions of the bones is required.

In order to create one animation, the work of creating a plurality of characters and performing surface modeling, the creation of a skeleton structure, skinning and muscle setting on each of the characters is required. For example, since the lengths and thicknesses of arms and legs and height vary depending on the character, the setting of muscles must be performed again whenever each character is created. As described above, in order to create a high-quality character, a creator who performs each process must perform correction, so that a long time and a large amount of labor are required to create each character.

### SUMMARY

Accordingly, an exemplary embodiment has been made keeping in mind the above problems occurring in the prior art, and an object of an exemplary embodiment is to automate a basic muscle creation process using the muscle information of an existing character when setting the muscles of a character.

In order to accomplish the above object, an exemplary embodiment provides a method of transforming the muscles of a character model, in which the muscles of a target model are created using the muscle information of a reference model, the method including creating a feature volume for the reference model based on skeleton and surface geometrical information of the reference model; subordinating the muscle information of the reference model to the feature volume for the reference model; creating a feature volume for the target model; comparing the feature volume for the reference model with the feature volume for the target model; and creating muscles for the target model using results of the comparison and the muscle information subordinate to the feature volume for the reference model.

Additionally, in order to accomplish the above object, an exemplary embodiment provides a system for transforming the muscles of a character model, in which the muscles of a target model are created using the muscle information of a reference model, the system including a reference model processor for creating a reference feature volume, that is, a 3D geometric shape, based on the skeleton and appearance information of the reference model, and subordinating the muscle information of the reference model to the feature volume; and a target model processor for deforming the reference feature volume to be suitable for the target model, and applying the muscle information of the reference model to the target model, thereby creating muscles for the target model based on the extent of the deformation of the reference feature volume.

### BRIEF DESCRIPTION OF THE DRAWINGS

The above and other objects, features and advantages of an exemplary embodiment will be more clearly understood from the following detailed description taken in conjunction with the accompanying drawings, in which:

FIG. 1 is a schematic block diagram of a system for transforming the muscles of a character model according to an exemplary embodiment;

FIG. 2 is a perspective view showing an example of a case where cylindrical feature volume are formed in a character model;

FIG. 3 is a diagram showing an example in which reference feature volume, that is, bounding boxes, are formed on the basis of the bone of the upper arm of a reference model;

FIG. 4 is a diagram showing the relationship between reference feature volume and muscles;

FIG. 5 is a diagram showing a target feature volume created by deforming the reference feature volume of FIG. 4 and accordingly deformed muscles in a target model; and

FIG. 6 is a flowchart schematically showing an example of a method of transforming the muscles of a character model according to an exemplary embodiment.

### DETAILED DESCRIPTION OF EMBODIMENTS

The advantages and characteristics of the invention and methods for accomplishing them will become more apparent from the following embodiments which will be described in detail in conjunction with the accompanying drawings. However, an exemplary embodiment is not limited to the following embodiments, but may be implemented in a variety of manners. These embodiments are provided to complete the disclosure of an exemplary embodiment and to help those having ordinary skill in the art to understand the scope of an exemplary embodiment. An exemplary embodiment is defined only by the claims. Meanwhile, the terms used in the specification are provided to describe the embodiments, but are not intended to limit an exemplary embodiment. In the specification, a singular form, unless specially mentioned otherwise, can include a plural form. The terms ‘include(s) or comprise(s)’ and ‘including or comprising’ used in the specification are not intended to exclude the existence or addition of one or more other components, steps, operations, and/or elements from a mentioned component, step, operation, and/or element.

A system for transforming the muscles of a character model (hereinafter referred to as the “muscle transformation system”) according to an exemplary embodiment is based on the technology of using the muscle information of a previously created character model (hereinafter referred to as the “reference model”) in a modeling process of creating the muscles of a new character model (hereinafter referred to as the “target model”).

A reference model is a previously created character model for providing muscle information, and is created by a designer or using three-dimensional (3D) scanning. Information about the appearance (such as meshes) of a model, information about a skeleton, skinning information representative of the relationship between a skeleton and a surface, and information about muscles disposed between a skeleton and a surface may have been previously set for a reference model, or a reference model may have been created based on these types of information.

In contrast, a target model is a character model for which muscles have not been arranged or set, unlike a reference model. For example, a target model may in a state where information about appearance and information about a skeleton on which skinning has been performed have been set. Since the skeleton of a target model has the same number of joints and the same connection structure as a reference model, the muscle information of the reference model can be easily transformed into that of the target model.

The muscle transformation system and method according to an exemplary embodiment may be applied to the case where all or part of the muscles of a target model are modeled. Accordingly, as described above, all or part of the skeleton of the target model correspond to all or part of the skeleton of the reference model, so that muscles can be transformed based on the same skeleton (joints) connection structure of a skeleton.

The skeleton information of each model includes information about the connection structure of bones, the number of joints, and the lengths of the bones. Since the appearance of each model can be represented using, for example, polygon meshes or a Non-Uniform Rational B-Splines (NURBS) curved surfaces, appearance information may include information about meshes or curved surfaces.

The muscle transformation system according to an exemplary embodiment uses a feature volume for a reference model (hereinafter referred to as the “reference feature volume”) in a process of creating the muscles of a target model by creating the reference feature volume and inserting muscle information into a reference feature volume.

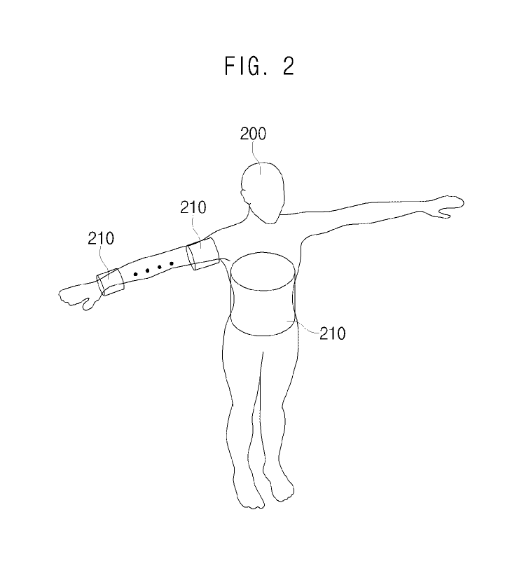

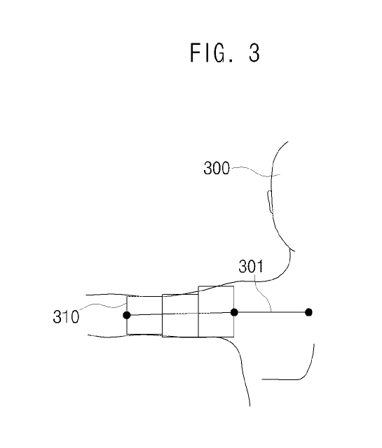

In an exemplary embodiment, a feature volume refers to a simple 3D geometric shape capable of representing geometrical information about the appearance of a character model, and is created based on skeleton information by considering geometrical information related to appearance. A feature volume may be a bounding box, a cylinder, an oval, or a sphere. Furthermore, a plurality of feature volume may be created. FIG. 2 is a perspective view showing a case where feature volume formed in a character model 200 are cylinders 210, and FIG. 3 is a side view showing a case where feature volume are bounding boxes 310. A feature volume is a shape reflecting the appearance (surface) of the character model 200, as shown in FIG. 2. Furthermore, as shown in FIG. 3, a feature volume may be disposed at the average location of the surface of a model or may be inscribed in a surface. Furthermore, as shown in FIG. 3, a feature volume may be disposed at the average location of the surface of a model or may be circumscribed about a surface.

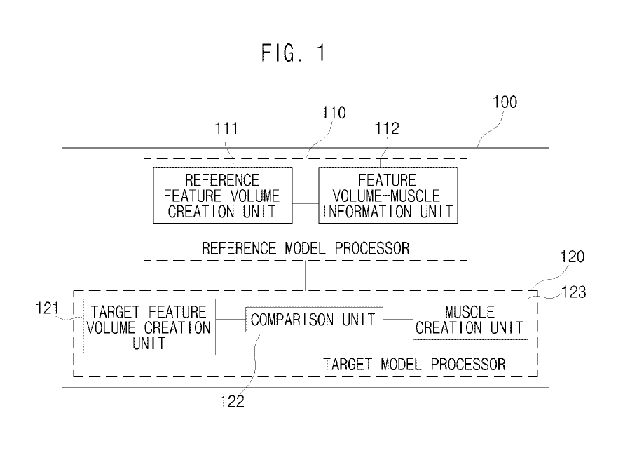

FIG. 1 is a schematic block diagram of a muscle transformation system 100 according to an exemplary embodiment. The muscle transformation system 100 includes a reference model processor 110 and a target model processor 120.

The reference model processor 110 creates a reference feature volume based on the skeleton and appearance information of a reference model, and subordinates the muscle information of the reference model to the reference feature volume. The reference model processor 110 includes a reference feature volume creation unit 111 and a feature volume-muscle information unit 112.

The reference feature volume creation unit 111 creates a reference feature volume which is a feature volume for a reference model. A reference feature volume is created based on the skeleton and appearance information of a reference model. For example, as shown in FIG. 3, reference feature volume which are three bounding boxes 310 reflecting the external shape of an arm around the bone 301 of a reference model 300 may be created.

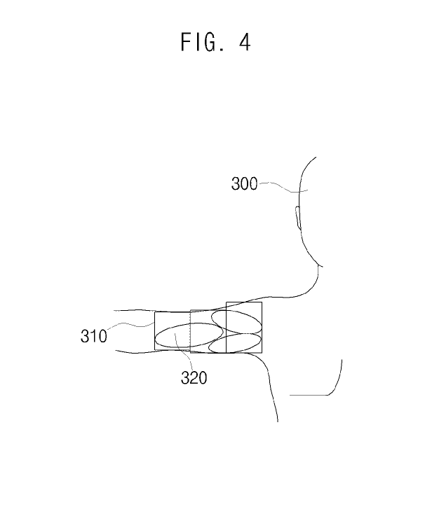

The feature volume-muscle information unit 112 records the muscle information of a reference model in a reference feature volume. FIG. 4 illustrates the relationship between bounding boxes 310, that is, reference feature volume, and muscles 320. As shown in FIG. 4, all or part of one muscle 320 may be included in one bounding box 310. That is, the relative locations, sizes and shapes of the muscles 320 may be recorded and stored in conjunction with the bounding boxes 310.

The reference model processor 110 previously stores the above-described information about the skeleton of a reference model, information about the surface of a reference model, skinning information and information related to a skeleton and muscles, thereby being able to operate the above-described reference feature volume creation unit 111 and feature volume-muscle information unit 112.

The target model processor 120 creates a target feature volume by deforming a reference feature volume to be suitable for a target model, and creates muscles in the target model by comparing the reference feature volume with the target feature volume and applying the muscle information of a reference model to the target model. The target model processor 120 includes a target feature volume creation unit 121, a comparison unit 122, and a muscle creation unit 123.

The target feature volume creation unit 121 deforms a reference feature volume to be suitable for a target model based on the skeleton information of the target model. Hereinafter a deformed reference feature volume is referred to as a target feature volume. For example, a target feature volume is created to be suitable for the direction and length of a bone of a target model.

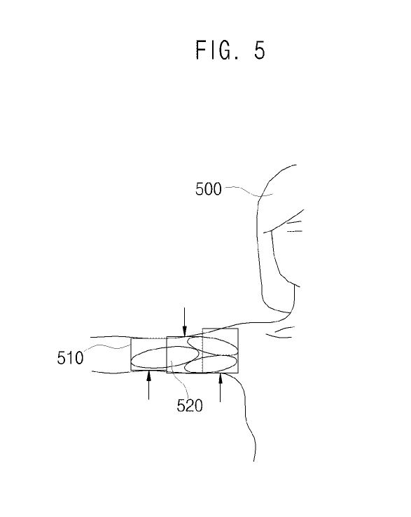

The comparison unit 122 extracts the extent of the deformation of a reference feature volume by comparing a reference feature volume with a target feature volume. The extent of the deformation of a feature volume may be represented using, for example, the variations in the length, width and height of a bounding box 510, that is, the feature volume, as shown in FIG. 5.

The muscle creation unit 123 fits the muscle information of a reference model to a target model based on the data of the comparison unit 122, that is, the extent of the deformation of a reference feature volume. For example, since the muscle information of the reference model is subordinated to a bounding box, that is, a reference feature volume, the muscle information of the reference model may be deformed in proportion to the extent of the deformation of the reference feature volume. Thereafter, muscles 520 can be created in a target model 500 by applying deformed muscle information to the target model 500, as shown in FIG. 5.

The target model processor 120 previously stores the above-described information about the surface of a target model and information about the skeleton of the target model, thereby being able to operate the target feature volume creation unit 121, the comparison unit 122 and the muscle creation unit 123.

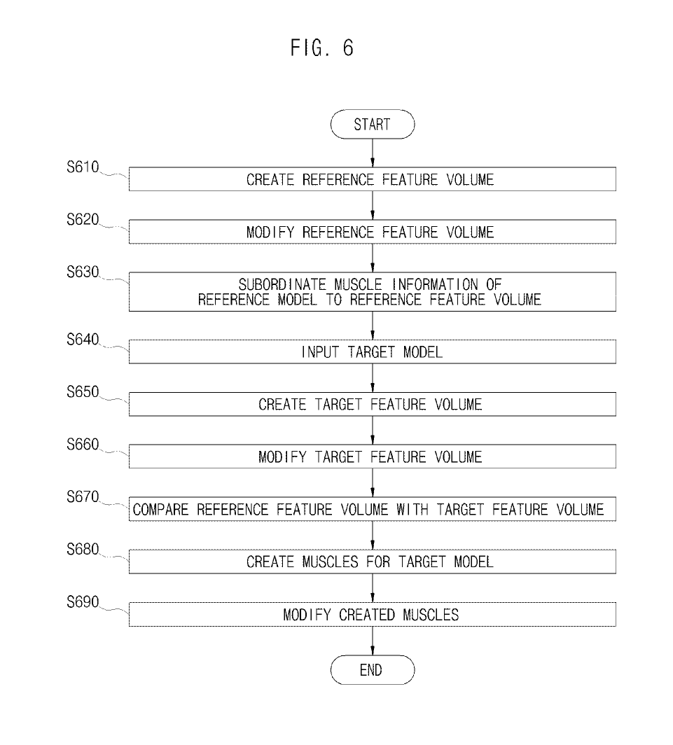

The muscle transformation method using the muscle transformation system will be described with reference to the accompanying drawings. FIG. 6 is a flowchart showing a muscle transformation method according to an embodiment of an exemplary embodiment.

First, the muscle transformation system 100 creates reference feature volume, that is, feature volume for a reference model, based on the skeleton and surface geometrical information of the reference model at step S610. For example, the reference feature volume may be created on the basis of a bone of the reference model. For example, as shown in FIG. 3, the locations and widths of the bounding boxes 310, that is, reference feature volume, may be determined by dividing the bone 301 of the upper arm into three equal parts. The sizes of the bounding boxes 310 may be determined to include or reflect the appearance of the reference model 300. Although the shape of a reference feature volume may be selected from among various shapes, any shape is created based on the bone 301, so that it is subordinate to the bone 301.

When the surface of a reference model is irregular or excessively rugged, a reference feature volume may not sufficiently reflect the appearance of the reference model. Accordingly, step S620 at which a person who performs modeling work modifies the reference feature volume after creating the reference feature volume may be further included.

The muscle transformation system 100 subordinates muscle information to the reference feature volume by recording the muscle information of the reference model in the reference feature volume at step S630. FIG. 4 shows an embodiment in which the muscles 320 are set for the reference model 300, in which information about the locations, sizes and shapes of the muscles 320 is subordinate to the bounding boxes 310, that is, reference feature volume. Since all or part of each muscle is included in each reference feature volume, the information of the muscles 320 is recorded based on the bounding boxes 310, that is, reference feature volume. Muscles may be represented using, for example, muscle controllers for attaching muscles to joints and performing control or the locations of the vertices of muscle surfaces. The locations of muscles are recorded using controllers or vertices, and, at the same time, the sizes and shapes of the muscles are recorded according to a calculation model for the variation in muscle shape based on the motion of a skeleton. The number of, points, sizes and shapes of controllers or vertices for representing muscles may vary depending on the type of muscle.

Once the feature volume for the reference model is created and the muscle information is recorded at steps S610˜S630 step, a target model, that is, a new character, is input at step S640. The target model is similar in skeleton information to the reference model, thereby enabling the muscle information of the reference model to be easily used. The target model may be identical, for example, in the bone connection structure or the number of joints, to the reference model. The muscle transformation system 100 receives the target model, and then performs the following process of creating muscles for the target model.

When the target model is input at step S640, the muscle transformation system 100 creates a target feature volume, that is, a feature volume for the target model, at step S650. For example, when the direction and length of each joint are made identical to those of the target model by applying the skeleton information of the reference model to the target model, the reference feature volume subordinate to the bone of the reference model are deformed. For example, as the direction and length of the bone to which the reference feature volume belong are made identical to the direction and length of the bone of the target model, the reference feature volume is deformed and the target feature volume is created. For example, when a bounding box is used as a reference feature volume, the width, length and height of each bounding box 510 may be varied, as shown in FIG. 5. The muscle transformation system 100 has stored a plurality of matching algorithms for creating target feature volume. A target feature volume may be created using a matching algorithm depending on the type of reference feature volume.

When the surface of a target model is irregular or excessively rugged, a target feature volume may not sufficiently reflect the appearance of the target model. Accordingly, step S660 at which a person who performs modeling work modifies the target feature volume after creating the target feature volume may be further included.

Thereafter, the muscle transformation system 100 compares the reference feature volume with the target feature volume at step S670. The extent of the variation of the reference feature volume can be extracted by comparing the two feature volume with each other. In the above-described case of FIG. 5, the variations in the width, length and height of the bounding boxes 510 can be extracted. Since muscle information is subordinate to the bounding boxes 310, that is, reference feature volume, the muscle information varies based on the bounding boxes 510.

The muscle transformation system 100 creates muscles in the target model using the results of the comparison at step S670 and the muscle information of the reference model at step S680. The locations, shapes or sizes of the muscles of the reference model are relatively recorded on the basis of the reference feature volume. Accordingly, muscles are created in the target model by varying the muscle information subordinate to the reference feature volume by the variations and applying the varied muscle information to the target model. FIG. 5 shows a state in which the arm of the target model 500 becomes thin and the muscles 520 become thin accordingly.

Depending on the muscle transformation system 100, muscles automatically created in a target model may not reflect the delicate features of the target model. Accordingly, step S690 at which a person who performs modeling work modifies muscles after the muscles have been created in the target model may be further included.

In another embodiment of an exemplary embodiment, at target feature volume creation step S650, the muscle transformation system 100 according to an exemplary embodiment can create a target feature volume for a target model at a step similar to step S610 of creating the reference feature volume rather than deforming the reference feature volume. For example, a target feature volume may be created based on the skeleton information of a target model, for example, a bone. Target feature volume may be formed by dividing the bone of the upper arm of a target model into three equal parts, as in the case where the reference feature volume are formed by dividing the bone 301 of the upper arm of the reference model 300 into three equal parts, as shown in FIG. 3. Here, in the case of newly creating a target feature volume according to the present embodiment, rather than deforming a reference feature volume to be suitable for a target model, the target feature volume must be created in the same conditions for the reference feature volume. The reason for this is to accurately extract variations by comparing the reference feature volume with the target feature volume. The same conditions mean, for example, the same location of a bone, the same type of feature volume and the same number of feature volume.

According to an exemplary embodiment, when a new character is created, the muscle information of a reference character model can be transformed using the method of an exemplary embodiment, so that the work of creating a character can be performed rapidly.

Furthermore, since the muscles of a new character are designed based on the muscle data of a reference model, there is the advantage of maintaining consistency between characters.

Furthermore, when reference muscles are used for a new character, all muscles must be manually modified if there is no method of transforming the muscles. When the method according to an exemplary embodiment is used, influence resulting from the difference in character is incorporated into basic factors, such as size and thickness, to be suitable for the variation in the appearance of the character, so that a creator can reduce work time by performing only modification based on detailed differences in muscles.

Furthermore, when work is performed on a plurality of characters, the work starts with a consistent muscle shape, so that the creation of heterogeneous muscle shapes between the characters can be reduced.

Moreover, the efficiency of muscle modeling work can be increased by modifying a feature volume, instead of separately modifying individual muscles, when additionally modifying the muscles.

Although the preferred embodiments of an exemplary embodiment have been disclosed for illustrative purposes, those skilled in the art will appreciate that various modifications, additions and substitutions are possible, without departing from the scope and spirit of the invention as disclosed in the accompanying claims.

What is claimed is:

1. A method of transforming muscles of a character model, in which muscles of a target model are created using muscle information of a reference model, the method comprising:
creating a feature volume for the reference model based on skeleton and surface geometrical information of the reference model;
subordinating the muscle information of the reference model to the feature volume for the reference model;
creating a feature volume for the target model;
comparing the feature volume for the reference model with the feature volume for the target model; and
creating muscles for the target model using results of the comparison and the muscle information subordinated to the feature volume for the reference model.

2. The method as set forth in claim 1, wherein the feature volume for the reference model is a three-dimensional (3D) geometric shape created based on a bone of the reference model.

3. The method as set forth in claim 1, wherein the subordinating the muscle information comprises relatively recording locations, sizes and shapes of the muscles of the reference model in the feature volume for the reference model.

4. The method as set forth in claim 1, wherein the creating a feature volume for the target model comprises creating the feature volume for the target model by deforming the feature volume of the reference model to be suitable for the target model.

5. The method as set forth in claim 4, wherein the creating a feature volume for the target model comprises deforming the feature volume of the reference model to be suitable for a direction or a length of a skeleton of the target model.

6. The method as set forth in claim 1, wherein the creating a feature volume for the target model comprises creating a feature volume having a 3D geometric shape using skeleton and surface geometrical information of the target model.

7. The method as set forth in claim 6, wherein the feature volume for the target model is a 3D geometric shape which reflects a surface shape of the target model based on a bone of the target model.

8. The method as set forth in claim 1, wherein the comparing the feature volume for the reference model with the feature volume for the target model comprises comparing skeleton information to which the feature volume for the reference model belongs with skeleton information to which the feature volume for the target model belongs, thereby extracting variations in direction or length between the pieces of skeleton information.

9. The method as set forth in claim 1, further comprising modifying the feature volume for the reference model.

10. The method as set forth in claim 1, further comprising modifying the muscles of the target model by modifying the feature volume for the target model.

11. The method as set forth in claim 1, wherein the reference model and the target model have an identical bone connection structure and an identical number of joints.

12. The method as set forth in claim 1, wherein part of the target model for which the muscles will be created and part of the reference model corresponding to the part of the target model have an identical bone connection structure and an identical number of joints.

13. A system for transforming muscles of a character model, in which muscles of a target model are created using muscle information of a reference model, the system comprising:
a reference model processor for creating a reference feature volume, that is, a 3D geometric shape, based on skeleton and appearance information of the reference model, and subordinating muscle information of the reference model to the feature volume; and
a target model processor for deforming the reference feature volume to be suitable for the target model, and applying muscle information of the reference model to the target model, thereby creating muscles for the target model based on the extent of the deformation of the reference feature volume.

14. The system as set forth in claim 13, wherein part of the target model for which the muscles will be created and part of the reference model corresponding to the part of the target model have an identical bone connection structure and an identical number of joints.

15. The system as set forth in claim 13, wherein the reference model processor has stored information about a surface of the reference model, information about a skeleton of the reference model, skinning information representative of relationship between the surface and the skeleton, and information about muscles arranged between the skeleton and the surface.

16. The system as set forth in claim 13, wherein the reference model processor comprises:
a reference feature volume creation unit for creating a reference feature volume having a shape which reflects an appearance of the reference model based on a bone of the reference model; and
a feature volume-muscle information unit for recording muscle information of the reference model in the reference feature volume.

17. The system as set forth in claim 16, wherein the muscle information is information about relative locations, sizes and shapes of the muscles for the reference feature volume.

18. The system as set forth in claim 13, wherein the target model processor has stored information about a surface of the target model and information about a skeleton of the target model.

19. The system as set forth in claim 13, wherein the target model processor comprises:
a target feature volume creation unit for creating a target feature volume, that is, a feature volume for the target model, by deforming the reference feature volume based on the skeleton information of the target model;
a comparison unit for comparing the reference feature volume with the target feature volume, thereby obtaining the extent of deformation; and
a muscle creation unit for creating muscles in the target model by applying muscle information of the reference model to the target model based on the extent of the deformation.

20. The system as set forth in claim 19, wherein the skeleton information of the target model is at least one of a direction and a length of a skeleton of the target model.
